(19) United States
(12) Patent Application Publication
(10) Pub. No.: US 2022/0270338 A1
(43) Pub. Date: Aug. 25, 2022

(54) DIGITAL IMAGE CAPTURE AND FITTING METHODS AND SYSTEMS

(71) Applicant: EIFLE, INC., Hempstead, NY (US)

(72) Inventor: Leonard ADAMS, Hempstead, NY (US)

(21) Appl. No.: 17/581,411

(22) Filed: Jan. 21, 2022

Related U.S. Application Data
(63) Continuation of application No. PCT/US2020/043486, filed on Jul. 24, 2020.
Application No. PCT/US2020/043486 is a continuation of application No. PCT/CN2019/097607, filed on Jul. 25, 2019.

(51) Int. Cl. G06T 19/20; G06T 7/60; G06Q 30/06

(52) U.S. Cl. CPC G06T 19/20; G06T 7/60; G06Q 30/0643; G06T 2207/30196; G06T 2219/2016

(57) ABSTRACT

A system and method for generating a proportionately scaled three dimensional model of a user, having an article of clothing fitted is disclosed herein. In some embodiments, the method comprises, receiving a plurality of images displaying a body of said user, using said plurality of images to generate one or more measurements of one or more portions of said body of said user, using said one or more measurements to generate said proportionately scaled three dimensional model of said body of said user, fitting said article of clothing to said proportionately scaled three dimensional model of said body of said user; and providing said proportionately scaled three dimensional model having said article of clothing fitted thereon for display on a user interface of an electronic device of said user.

### CROSS-REFERENCE

This application is a continuation of International Application No. PCT/US2020/043486 (Attorney Docket No. 55095-701.602), filed Jul. 24, 2020, which is a continuation of International Application No. PCT/CN2019/097607 (Attorney Docket No. 55095-701.601), filed Jul. 25, 2019, which are incorporated herein by reference in their entirety.

### BACKGROUND

Online shopping for clothing is becoming more widespread. Online shoppers can browse through numerous clothing items from different brands and having different sizes and colors. Shoppers can choose their desired size or color prior to purchasing the article of clothing. Some online shopping apps or software display the clothing item on a generic model to give a general understanding of the flow of the clothing item on the body.

### SUMMARY

Various embodiments of the present disclosure address the demand for an accurate measurement and fitting platform. The present disclosure provides methods and systems for accurate measurement of portions of the body or the whole body of an individual, using two-dimensional (2D) photographs. The present disclosure further provides methods and systems for generating a life-like three-dimensional (3D) mannequin, proportionately scaled to the user. The 3D model may be manipulated and articles of clothing may be fitted to the mannequin using a smart device application or a computer software program.

The use of 2D images for measurements may allow for more accurate measurements of portions or the whole body of the user. The use of 2D images instead of 3D images may also reduce the quality or price of the camera needed to obtain accurate measurement and the amount of local storage required to store the image data.

An aspect of the disclosure provides a method for generating a proportionately scaled three-dimensional model of a user having an article of clothing fitted thereon is presented. The method may comprise (a) receiving a plurality of images displaying a body of the user; (b) using the plurality of images to generate one or more measurements of one or more portions of the body of the user; (c) using the one or more measurements to generate the proportionately scaled three-dimensional model of the body of the user; (d) fitting the article of clothing to the proportionately scaled three-dimensional model of the body of the user; and (e) providing the proportionately scaled three-dimensional model having the article of clothing fitted thereon for display on a user interface of an electronic device of the user.

In some embodiments, the plurality of images may be captured using a camera assembly disposed adjacent to a mirror. In some cases, the camera assembly and the mirror may be a single, integrated system. In other cases, the camera assembly and the mirror may be physically separated from one another. The camera assembly may comprise one or a plurality of cameras. In some cases, the plurality of images may be captured at different angles of the user with respect to the mirror. The user may be standing on a rotating platform in front of the mirror. The platform may rotate 360 degrees or less than 360 degrees. The user may be standing on the ground or a fixed platform and may rotate manually. In some embodiments, the plurality of images may be two-dimensional images. In some embodiments, the camera may be fixed in position.

In some embodiments, the proportionately scaled three dimensional model may be a non-computer generated image. The model may be manipulated by the user on the electronic device. For example, the 3D model having fitted an article of clothing thereon, may be rotated by the user on the electronic device.

In some embodiments, using the plurality of images to generate one or more measurements of one or more portions of the body of the user may comprise applying a segmentation algorithm to the plurality of images.

In some embodiments, the article of clothing may be selected from a plurality of articles of clothing stored in a computer database. The fitting of the article of clothing may show how various sizes of a particular article of clothing fit on the user's body. The electronic device may be a mobile device.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 schematically illustrates an example of an image capturing system.

FIG. 2 schematically illustrates an example of a full-length mirror camera system used in some embodiments of the present disclosure.

FIG. 3 is a flowchart of a process for capturing images from a user and generating a 3D, life-like mannequin of the user.

FIG. 4 schematically illustrates an example of a user interface displaying a 3D life like model of a user and fitting items of clothing on the 3D model.

FIG. 5 shows a computer system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Online shopping for clothing can be challenging. One of the challenges may be the proper fitting of clothing items. The online shopper may have to buy different sizes of the same item of clothing if shopping from different manufacturers because the same size does not guarantee the same dimensional measurements among clothing manufacturers. Furthermore, the flow of an item of clothing on a specific body type and the harmony of the color of the clothing item with facial features of the wearer can be among several parameters that make the choice of a clothing item by an online shopper more difficult. The embodiments of the disclosure described herein can enable accurate measurements of portions of the body or the whole body of a user in order to generate a proportionately scaled 3D model of the user. The 3D model may contain unique features of the user including skin tone, body shape, body size, and facial and limb features.

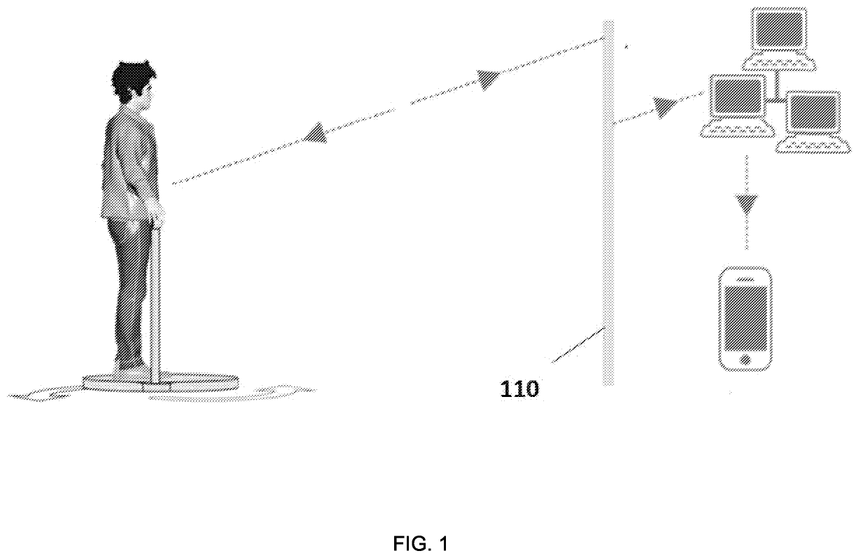

FIG. 1 schematically illustrates a system for capturing images of a user. The user may be standing in front of a reflective surface such as a mirror with a camera assembly adjacent to the mirror. The camera may be integrated into the mirror, or it may be a separate component. An example of a mirrored photography system can be found in U.S. Pat. No. 9,348,198, which is fully incorporated herein by reference. In some implementations, one camera may be used to capture the images. In other cases, a plurality of cameras may be used to capture the images.

A non-limiting example of using multiple cameras may be the use of three cameras. Two camera lenses may be positioned along the sides of the reflective surface. A third camera may be positioned at the bottom or top of the reflective surface. The camera lenses may be synchronized to capture images sequentially or simultaneously or in any other order. The use of a plurality of camera lenses may increase the accuracy of measurements, for example, depth or distance measurements and may eliminate the need for defining the user's distance from the reflective surface prior to estimating the measurements. Other camera arrangements are possible. For example, all three cameras may be positioned above or below the reflective surface. In some cases, the system may have only two cameras.

The images may be two-dimensional images. In some embodiments, the camera may be in a fixed position relative to the rest of the system in order to capture images. In other cases, the camera may be able to move relative to the rest of the system to capture images of the user from different angles. In some embodiments, the user may be standing and the whole body of the user may be reflected in the mirror. In other cases, only portions of the body of the user may be visible (e.g., the user's upper body or the user's lower body). In some embodiments, the user may stand at a predefined distance from the reflective surface. In some cases, the distance at which the user stands may be illuminated on the standing surface by a light. The light source may be adjacent to the reflective surface (e.g., on one or both sides of the reflecting surface or above or below the reflecting surface). In some embodiments, the user may stand at an arbitrary distance from the reflective surface. The user may stand at least about 1 foot (ft.), 2 ft., 3 ft., 4 ft., 5 ft., 6 ft., 7 ft., 8 ft., 9 ft., 10 ft., or more away from the reflective surface.

In some embodiments, the system may include a platform configured to rotate or spin the user in front of the reflective surface. The rotation may be relative to a longitudinal axis of the user's body and perpendicular to the surface of the floor or earth. The rotation of the user may span over 360 degrees or less. Images may be captured at different angles relative to the user's longitudinal axis when the user rotates. The platform may include a motor configured to drive the rotation of the platform. The platform may additionally include a user interface to control the motor. The user interface may include a start and stop button, for example.

In some cases, the system may not include a platform. In such cases, the user may manually rotate his or her body.

The plurality of 2D images may be captured from the user from different angels. The system may capture 1, 5, 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, or 10,000 or any number of images that is within a range defined by any two of the preceding values.

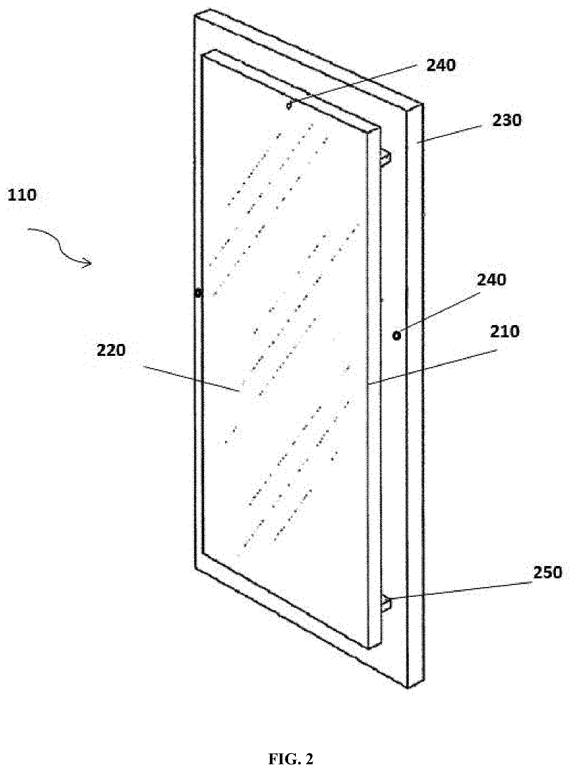

FIG. 2 schematically illustrates an example of the full-length mirrored photography system 110. The mirrored photographing system may include a reflective surface 220, a back plate 230 for stabilization of the reflective surface, viewing apertures 240 and support braces 250. The reflective surface 220 can cover the entire front of the mirror 210, or only a portion thereof. The back plate 230 (e.g., stabilizing plate) may provide structural support and can be of any size or shape (e.g., square, rectangular, oval, circular, etc.), and can be complementary in size and shape to that of the mirror 210. For example, the back plate 230 and the mirror 210 may both be rectangular with the back plate 230 slightly larger than the mirror 210 (thereby providing an aesthetic border to the mirror 210). Alternatively, the back plate 230 can be the same size and shape as the mirror 210, or the back plate 230 can be smaller than the mirror 210 (e.g., such that the back plate 230 is not visible from the front of the mirror 210). The mirror could be glass, acrylic, or plastic, where an acrylic or plastic mirror is easier to drill and more durable (e.g., prevents shattering). The mirror 210 is shown as being full-length and of a rectangular shape, but the mirror 210 can be any of a variety of suitable types (e.g., floor mirror, table mirror, wall mirror, etc.), sizes (e.g., full-length mirror) and shapes (e.g., square, rectangular, oval, circular, etc.).

At least a portion of the front of the mirror 210 may include the reflective surface 220 (e.g., reflective front surface) for a person to view him or herself in the mirror 210. The reflective surface 220 can cover the entire front of the mirror 210, or only a portion thereof.

The viewing apertures 240 can be through holes that extend from the mirror front surface to the mirror back surface and can have variety of shapes. The mirror 210 (e.g., mirrored plate) is mounted to the back plate 230 by the one or more supporting braces 250 (e.g., railing system. More specifically, for each supporting brace 250, a first side of the supporting brace 250 may be attached to (e.g., contacting) a back surface of the mirror 210, and a second side of the supporting brace 250 may be attached to (e.g., contacting) the front surface of the back plate 230 (e.g., the first side opposite the second side). In other words, the supporting braces 250 may be positioned between the mirror 210 and the back plate 230 to attach them to one another. The mirror 210 can have contact portions adapted for connection to the support braces 250 (e.g., pre-fixed holes in the mirror 210 and/or support braces 250). In this way, the mirror 210 can be offset from the back plate 230, thereby providing space for positioning of the camera assembly there between. Further, the supporting braces 250 can provide structural rigidity to the back plate 230 and/or mirror 210 (e.g., reducing flexibility in the mirror 210).

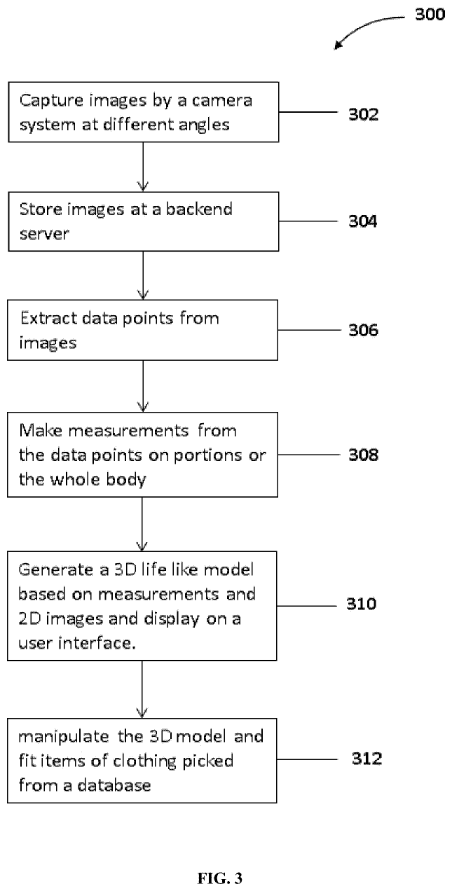

FIG. 3 is a flow chart of a process 300 for capturing images from a user and generating a 3D life like mannequin of the user. The method in general may comprise, receiving a plurality of images displaying a body of the user, using the plurality of images to generate one or more measurements of one or more portions of the body of the user, using the one or more measurements to generate the proportionately scaled three dimensional model of the body of the user, fitting the article of clothing to the proportionately scaled three dimensional model of the body of the user, and providing the proportionately scaled three dimensional model having the article of clothing fitted thereon for display on a user interface of an electronic device of the user.

In a step 302, a plurality of images may be captured from the user from different angles. The images may be captured using the mirrored photographing system, described in FIG. 1 and FIG. 2. For example, the images may be captured using three different cameras while the user's body rotates on the platform. In this way, many images of the user's body may be captured from many different angles. The images can be transferred through a wired connection or wirelessly to an electronic computing device. The electronic computing device may be a server, computer, laptop, smart phone, smart watch, or the like.

In a step 304, the electronic computing device may transmit and store the images to a backend server, e.g., a remote cloud server.

In a step 306, data points may be extracted from the images for body measurements. Data points may be extracted from a single image of the plurality of images, a subset of images of the plurality of image, or all of the plurality of images.

In a step 308, the data points can be used to measure different portions of the body of the user, e.g., the waist, bust, neck, shoulders, arms, legs or other body portions or the whole body of the user. Measurements can be made using different algorithms or software programs such as machine learning algorithms, artificial intelligence (AI) algorithms, feature extraction software, 3D modeling software, or the like. As a non-limiting example, the images may be segmented using segmentation algorithms. The segmentation algorithm may trace an area of the body in a subset of the plurality of the images. Segmentation algorithms can be used to locate objects and boundaries, e.g., limbs or body contours, in the images. The result of the segmentation process can be a set of segments that collectively cover the entire body or a portion of a body of the user. The use of three cameras and multiple image angles can make this segmentation process more accurate, e.g., by allowing data points to be correlated between different images taken from different angles and by different cameras.

In a step 310, a life-like, 3D model can be generated from the measurements generated in step 308, and may be displayed on a user interface such as a computer, laptop, smart phone, or smart watch. The 3D model may be displayed in video format. The video can be segmented using segmentation algorithms to allow for manipulation of the model by the user. The 3D model may be a non-computer generated image mannequin including the features of the user such as skin tone, eye color, hair color and limb features. The 3D model may display the whole body of the user or a portion of it such as the waist to the head or the waist to the feet. The 3D model may be proportionately scaled to reflect the real size of the whole body or a portion of the body of the user such as the waist to the head or the waist to the feet.

In a step 312, the 3D model may be manipulated using a mobile application or a computer software program. The model may be rotated or moved around or moved in different angles. In some embodiments, a database including clothing items may be accessed by the mobile application. The database may be accessed, for example, remotely through a cloud server. The manipulation of the 3D model may include fitting different clothing items on the 3D model. In some embodiments, variations of size or color of the same clothing item or different clothing items may be fitted on the 3D model for comparison. The model may be rotated to display the flow of a clothing item from different angles. The degree of rotation of the model may be controlled by the user.

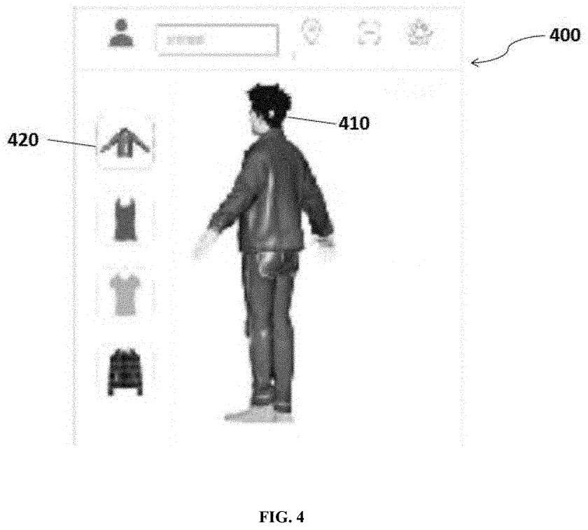

FIG. 4 shows an example of an application such as a smart phone application including a graphical user interface (GUI). The GUI may allow the user to interact with the proportionality scaled 3D model for the purpose of fitting different items of clothing to the proportionately scaled 3D model. For example window 400 may show a digital mannequin 410 of the user. The digital mannequin may be a non-computer generated image mannequin of the user. The digital mannequin may include the facial or body features of the user, e.g., skin color, hair color, eye color, hair texture, body shape, body size, or any other body or limb features. The digital mannequin 410 may be configured to rotate up to 360 degrees. In some embodiments, the user may select an article of clothing 420 from a plurality of articles of clothing stored in a computer database. The user then may fit the article of clothing 420 to digital mannequin 410 on the graphical user interface. The fitting of the article of clothing may show how various sizes of a particular article of clothing fit on the user's body. In some embodiments, the information related to the article of clothing 420 such as the size, brand or fabric may be stored in a computer database accessible by the user for future reference.

In some cases, the application may also be configured to control or initiate the mirrored photography system described in reference to FIG. 1. For example, the application may be configured to initiate rotation of the platform or initiate a photography sequence.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

### Computer Systems

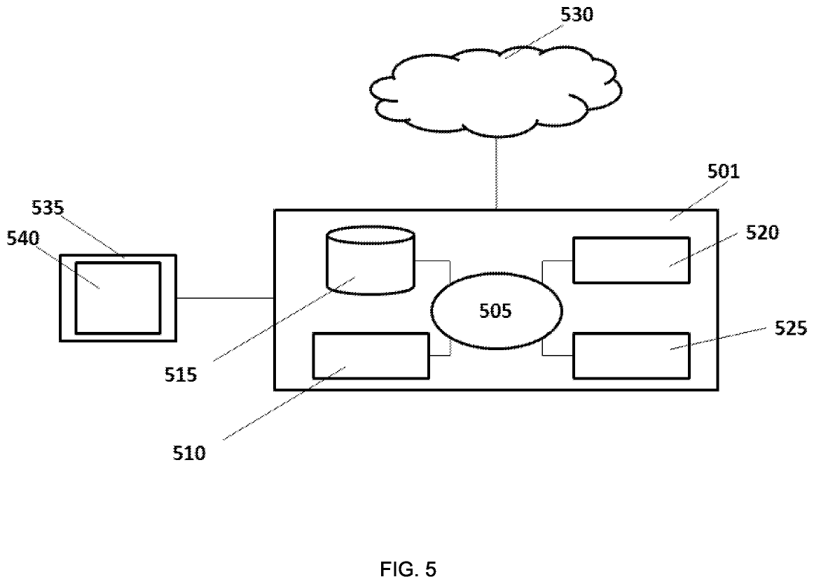

The present disclosure provides computer systems that are programmed to implement methods of the disclosure. FIG. 5 shows a computer system 501 that is programmed or otherwise configured to generate a proportionately scaled three dimensional model of a user having an article of clothing fitted thereon. The computer system 501 can be configured to perform the 3D modeling and fitting process described herein. Alternatively or additionally, the computer system 501 can be configured to run the application described in FIG. 4 The computer system 501 can be an electronic device of a user or a computer system that is remotely located with respect to the electronic device. The electronic device can be a mobile electronic device.

The computer system 501 includes a central processing unit (CPU, also “processor” and “computer processor” herein) 505, which can be a single core or multi core processor, or a plurality of processors for parallel processing. The computer system 501 also includes memory or memory location 510 (e.g., random-access memory, read-only memory, flash memory), electronic storage unit 515 (e.g., hard disk), communication interface 520 (e.g., network adapter) for communicating with one or more other systems, and peripheral devices 525, such as cache, other memory, data storage and/or electronic display adapters. The memory 510, storage unit 515, interface 520 and peripheral devices 525 are in communication with the CPU 505 through a communication bus (solid lines), such as a motherboard. The storage unit 515 can be a data storage unit (or data repository) for storing data. The computer system 501 can be operatively coupled to a computer network (“network”) 530 with the aid of the communication interface 520. The network 530 can be the Internet, an internet and/or extranet, or an intranet and/or extranet that is in communication with the Internet. The network 530 in some cases is a telecommunication and/or data network. The network 530 can include one or more computer servers, which can enable distributed computing, such as cloud computing. The network 530, in some cases with the aid of the computer system 501, can implement a peer-to-peer network, which may enable devices coupled to the computer system 501 to behave as a client or a server.

The CPU 505 can execute a sequence of machine-readable instructions, which can be embodied in a program or software. The instructions may be stored in a memory location, such as the memory 510. The instructions can be directed to the CPU 505, which can subsequently program or otherwise configure the CPU 505 to implement methods of the present disclosure. Examples of operations performed by the CPU 505 can include fetch, decode, execute, and writeback.

The CPU 505 can be part of a circuit, such as an integrated circuit. One or more other components of the system 501 can be included in the circuit. In some cases, the circuit is an application specific integrated circuit (ASIC).

The storage unit 515 can store files, such as drivers, libraries and saved programs. The storage unit 515 can store user data, e.g., user preferences and user programs. The computer system 501 in some cases can include one or more additional data storage units that are external to the computer system 501, such as located on a remote server that is in communication with the computer system 501 through an intranet or the Internet.

The computer system 501 can communicate with one or more remote computer systems through the network 530. For instance, the computer system 501 can communicate with a remote computer system of a user (e.g., send information such as measurement data or other data). Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 501 via the network 530.

Methods as described herein can be implemented by way of machine (e.g., computer processor) executable code stored on an electronic storage location of the computer system 501, such as, for example, on the memory 510 or electronic storage unit 515. The machine executable or machine readable code can be provided in the form of software. During use, the code can be executed by the processor 505. In some cases, the code can be retrieved from the storage unit 515 and stored on the memory 510 for ready access by the processor 505. In some situations, the electronic storage unit 515 can be precluded, and machine-executable instructions are stored on memory 510.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 501, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 501 can include or be in communication with an electronic display 535 that comprises a user interface (UI) 540 for providing, for example, the generated 3D proportionately scaled model of the user. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 505. The algorithm can, for example, generate one or more measurement data points of one or more portions of the body of the user from the plurality of images of. The algorithms may use machine learning or artificial intelligence methods for making the measurements.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations or equivalents. It is intended that the following claims define the scope of the invention and that methods and structures within the scope of these claims and their equivalents be covered thereby.

What is claimed is:

1. A method for generating a proportionately scaled three dimensional model of a user having an article of clothing fitted thereon, comprising:
(a) receiving a plurality of images displaying a body of said user;
(b) using said plurality of images to generate one or more measurements of one or more portions of said body of said user;
(c) using said one or more measurements to generate said proportionately scaled three dimensional model of said body of said user;
(d) fitting said article of clothing to said proportionately scaled three dimensional model of said body of said user; and
(e) providing said proportionately scaled three dimensional model having said article of clothing fitted thereon for display on a user interface of an electronic device of said user.

2. The method of claim 1, wherein said plurality of images is captured using a camera assembly disposed adjacent to a mirror.

3. The method of claim 1, wherein said camera assembly comprises one camera.

4. The method of claim 1, wherein said camera assembly comprises a plurality of cameras.

5. The method of claim 2, wherein said plurality of images is captured at different angles of said user with respect to said mirror.

6. The method of claim 5, wherein said plurality of images is captured while said user is standing on a rotating platform.

7. The method of claim 6, wherein said rotating platform rotates 360 degrees.

8. The method of claim 6, wherein said rotating platform rotates less than 360 degrees.

9. The method of claim 5, wherein said plurality of images is captured while said user rotates manually on a fixed platform.

10. The method of claim 1, wherein said proportionately scaled three dimensional model is a non-computer generated image mannequin.

11. The method of claim 10, wherein said proportionately scaled three dimensional model is manipulated by said user on said electronic device of said user.

12. The method of claim 11, wherein manipulation of said proportionately scaled three dimensional model includes rotating said proportionately scaled three dimensional model.

13. The method of claim 1, wherein said article of clothing is selected from a plurality of articles of clothing stored in a computer database.

14. The method of claim 13, wherein said fitting shows how said article of clothing would fit on said body of said user.

15. The method of claim 1, wherein said electronic device is a mobile electronic device.

16. The method of claim 2, wherein said plurality of images comprises two dimensional images.

17. The method of claim 2, wherein said camera assembly is fixed in position.

18. The method of claim 1, wherein (b) comprises applying a segmentation algorithm to said plurality of images.

19. A non-transitory computer-readable medium comprising machine-executable code that, upon execution by one or more computer processors, implements a method for:
(a) receiving a plurality of images displaying a body of said user;
(b) using said plurality of images to generate one or more measurements of one or more portions of said body of said user;
(c) using said one or more measurements to generate said proportionately scaled three dimensional model of said body of said user;
(d) fitting said article of clothing to said proportionately scaled three dimensional model of said body of said user;
(e) displaying said proportionately scaled three dimensional model having said article of clothing fitted thereon on a user interface of an electronic device of said user; and
(f) manipulating said proportionately scaled three dimensional model having said article of clothing fitted thereon on said user interface.
